(19) United States
(12) Patent Application Publication
(10) Pub. No.: US 2024/0371172 A1
(43) Pub. Date: Nov. 7, 2024

(54) OBJECT DETECTION METHOD AND ELECTRONIC DEVICE FOR PERFORMING SAME METHOD

(71) Applicant: Nextchip Co., Ltd., Seongnam-si (KR)

(72) Inventor: Ho Hyon SONG, Seoul (KR)

(73) Assignee: Nextchip Co., Ltd., Seongnam-si, KG (KR)

(21) Appl. No.: 18/580,739

(22) PCT Filed: Sep. 17, 2021
(86) PCT No.: PCT/KR2021/012884

§ 371 Date: Jan. 19, 2024

(30) Foreign Application Priority Data
Aug. 4, 2021 (KR) 10-2021-0102749

(51) Int. Cl. G06V 20/58; G06T 7/55; G06V 20/64

(52) U.S. Cl. CPC G06V 20/58; G06T 7/55; G06V 20/647; G06T 2207/30244; G06T 2207/30252

(57) ABSTRACT

To detect an object, an embodiment may: calculate a first distance to a first region and a second distance to a second region of a target object in a first image captured from a first point of view; calculate a third distance to the first region and a fourth distance to the second region of the target object in a second image captured from a second point of view; calculate a first difference between the first distance and the third distance; calculate a second difference between the second distance and the fourth distance; and determine whether the target object is a three-dimensional object, on the basis of the first difference and the second difference.

### TECHNICAL FIELD

The following embodiments relate to technology of detecting an object, and specifically, to technology of detecting an object using images.

### BACKGROUND ART

A vehicle supporting an advanced driver-assistance system (ADAS) or an autonomous vehicle needs to automatically detect objects around the vehicle to assist a user or generate a path for the vehicle. For example, the vehicle may generate an image by capturing the front of the vehicle using a camera of the vehicle. The generated image may include roads, other vehicles, traffic lights, and people. The vehicle may detect an object in the image and may assist the user or may generate the path, based on the detected object.

### DISCLOSURE OF THE INVENTION

### Technical Goals

An embodiment may provide an object detection method performed by an electronic device.

An embodiment may provide an electronic device for detecting an object in an image.

However, the technical aspects are not limited to the aforementioned aspects, and other technical aspects may be present.

### Technical Solutions

According to an aspect, an object detection method performed by an electronic device includes calculating a first distance to a first region of a target object and a second distance to a second region of the target object in a first image captured at a first time point using a camera, calculating a third distance to the first region of the target object and a fourth distance to the second region of the target object in a second image captured at a second time point using the camera, calculating a first difference between the first distance and the third distance and calculating a second difference between the second distance and the fourth distance, and determining whether the target object is a three-dimensional object based on the first difference and the second difference.

The camera may be a monocular camera.

The first region comprises a lowest part of the target object, and the second region comprises an uppermost part of the target object.

The object detection method may further include detecting a first object in the first image, detecting a second object in the second image, and determining whether the first object and the second object are the same object as the target object.

The calculating of the first distance to the first region of the target object and the second distance to the second region of the target object in the first image captured at the first time point using the camera may include generating a first bird viewpoint image by changing a viewpoint of the first image, calculating the first distance from the camera to the first region of the target object in the first bird viewpoint image, and calculating the second distance from the camera to the second region of the target object in the first bird viewpoint image.

The object detection method may further include obtaining a first posture of the camera at the first time point, wherein the generating of the first bird viewpoint image by changing the viewpoint of the first image may include generating the first bird viewpoint image by changing the viewpoint of the first image based on the first posture.

The calculating of the third distance to the first region of the target object and the fourth distance to the second region of the target object in the second image captured at the second time point using the camera may include obtaining a second posture of the camera at the second time point, generating a second bird viewpoint image by changing a viewpoint of the second image based on the second posture, calculating the third distance from the camera to the first region of the target object in the second bird viewpoint image, and calculating the fourth distance from the camera to the second region of the target object in the second bird viewpoint image.

The determining of whether the target object is the three-dimensional object based on the first difference and the second difference may include determining that the target object is a two-dimensional object when the first difference is equal to the second difference.

The determining of whether the target object is the three-dimensional object based on the first difference and the second difference may include determining that the target object is the three-dimensional object when the first difference is not equal to the second difference.

The electronic device may be included in a vehicle, and when the target object is determined to be the three-dimensional object, the target object may be used to generate a path of the vehicle.

According to an another aspect, an electronic device includes a memory configured to store a program for detecting an object, and a processor configured to execute the program, wherein the program may be configured to perform calculating a first distance to a first region of a target object and a second distance to a second region of the target object in a first image captured at a first time point using a camera, calculating a third distance to the first region of the target object and a fourth distance to the second region of the target object in a second image captured at a second time point using the camera, calculating a first difference between the first distance and the third distance and calculating a second difference between the second distance and the fourth distance, and determining whether the target object is a three-dimensional object based on the first difference and the second difference.

The electronic device may be included in a vehicle supporting autonomous driving or a vehicle supporting an advanced driver-assistance system (ADAS).

The program may be further configured to perform controlling the vehicle based on the target object when the target object is determined to be the three-dimensional object.

The electronic device may further include the camera that is a monocular camera.

The first region may include a lowest part of the target object and the second region may include an uppermost part of the target object.

The program may be further configured to perform detecting a first object in the first image, detecting a second object in the second image, and determining whether the first object and the second object are the same object as the target object.

The calculating of the first distance to the first region of the target object and the second distance to the second region of the target object in the first image captured at the first time point using the camera may include obtaining a first posture of the camera at the first time point, generating a first bird viewpoint image by changing a viewpoint of the first image based on the first posture, calculating the first distance from the camera to the first region of the target object in the first bird viewpoint image, and calculating the second distance from the camera to the second region of the target object in the first bird viewpoint image.

The determining of whether the target object is the three-dimensional object based on the first difference and the second difference may include determining that the target object is a two-dimensional object when the first difference is equal to the second difference, and determining that the target object is the three-dimensional object when the first difference is not equal to the second difference.

According to another aspect, an object detection method performed by an electronic device includes calculating a first distance to a target feature point in a first image captured at a first time point using a camera, calculating a second distance to the target feature point in a second image captured at a second time point using the camera, and determining whether an object comprising the target feature point is a three-dimensional object based on a movement speed of the camera, the first distance, and the second distance.

### Effects

An object detection method performed by an electronic device may be provided.

An electronic device for detecting an object in an image may be provided.

### BRIEF DESCRIPTION OF DRAWINGS

FIG. 1 illustrates an example of a two-dimensional object drawn on the ground.

FIG. 2 illustrates an example of a two-dimensional object and a three-dimensional object that appear in a subsequent image.

FIG. 3 illustrates an example of an object projected in an image appearing by a three-dimensional object.

FIG. 4 illustrates an example of an object in an image appearing by a two-dimensional object.

FIG. 5 is a diagram illustrating a configuration of an electronic device according to an embodiment.

FIG. 6 is a flowchart of a method of detecting an object, according to an embodiment.

FIG. 7 is a flowchart of a method of determining whether objects in images are the same objects, according to an example.

FIG. 8 is a flowchart of a method of calculating a first distance to a first region of a target object and a second distance to a second region of the target object in a first image, according to an example.

FIG. 9 illustrates an example of a calculated first difference and a calculated second difference when a target object is a three-dimensional object.

FIG. 10 illustrates an example of a calculated first difference and a calculated second difference when a target object is a two-dimensional object.

FIG. 11 illustrates an example of a method of determining whether a target object is a three-dimensional object based on a first difference and a second difference.

FIG. 12 illustrates an example of a vehicle including an electronic device.

FIG. 13 is a flowchart of a method of controlling a vehicle based on a three-dimensional object, according to an example.

FIG. 14 is a flowchart of a method of detecting an object, according to another embodiment.

### BEST MODE FOR CARRYING OUT THE INVENTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments will be described in detail with reference to the accompanying drawings. When describing the embodiments with reference to the accompanying drawings, like reference numerals refer to like components and a repeated description related thereto will be omitted.

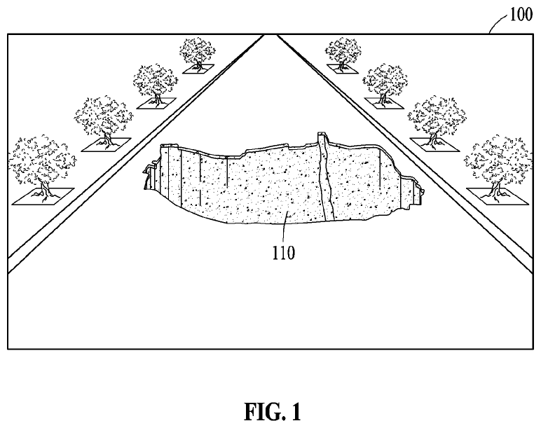

FIG. 1 illustrates an example of a two-dimensional object drawn on the ground.

Recently, deep learning methods based on images have been used as a method for autonomous driving in the automobile industry. The deep learning method may detect, using images, not only the location and size of a pedestrian/vehicle through learning an object detection model but also a general object that may obstruct driving on the road.

According to an example, in a situation where a virtual object is drawn, using paint, on the road where a vehicle is driving, such as an art road or a parallax road, the object detection model using an image from a monocular camera may not determine whether an object 110 in an image 100 is a two-dimensional object (i.e., a picture) existing on the surface of the ground or a three-dimensional object raised above the ground, without using additional sensors such as radar or lidar.

According to an embodiment, motion parallax may be used to determine whether the object 110 is a two-dimensional object or a three-dimensional object. Motion parallax refers to a phenomenon that when an observer moves, a nearby object appears to move faster and a farther object appears to move slower or a phenomenon that when the observer is in a fixed state and two objects moving at the same speed have different distances, the object at a closer distance appears to move faster than the farther object.

According to an embodiment, when a camera capturing an image moves with respect to an object and captures a plurality of images, whether the object is a three-dimensional object with height may be determined by comparing sizes of objects in the images.

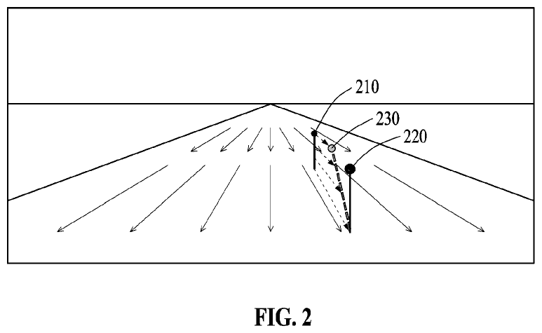

Hereinafter, a method of detecting an object in an image is described in detail with reference to FIGS. 2 to 11.

FIG. 2 illustrates an example of a two-dimensional object and a three-dimensional object that appear in a subsequent image.

According to an example, an object 210 may be detected based on a preceding image captured by a camera at a first time point. However, whether the object 210 is a two-dimensional image or a three-dimensional image may not be determined based on the preceding image alone. Subsequently, an object 220 or an object 230 may be detected based on a subsequent image captured by the camera at a second time point.

When the object 210 is a three-dimensional object, the object 210 may appear as the object 220 in the subsequent image, and when the object 210 is a two-dimensional object, the object 210 may appear as the object 230 in the subsequent image.

According to an embodiment, whether the object is a three-dimensional object may be determined through comparison between a shape of the object 210 in the preceding image and a shape of the object 220 or 230 appearing in the subsequent image.

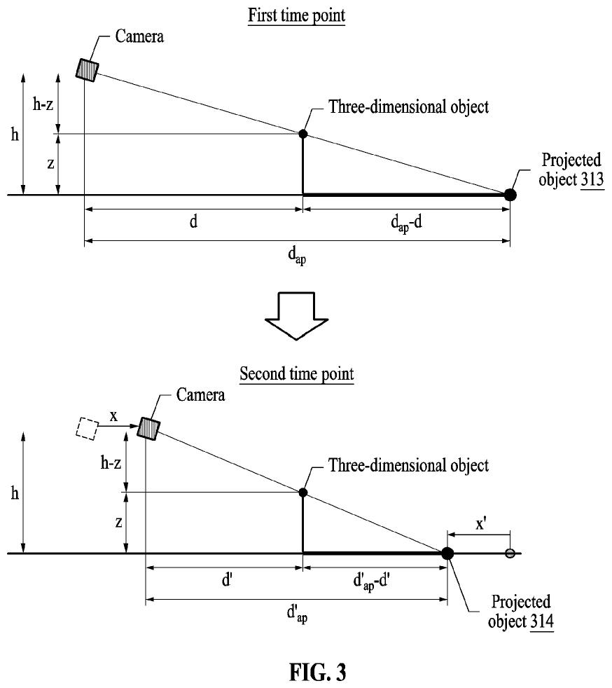

FIG. 3 illustrates an example of an object projected in an image appearing by a three-dimensional object.

At a first time point, an object 313 on which a three-dimensional object is projected may appear in a first image capturing a scene including the three-dimensional object. A length (dₐₚ-d) of the projected object 313 may vary depending on the distance between a camera and the three-dimensional object. The greater the distance between the camera and the three-dimensional object, the longer the length of the projected object 313 may become.

When a position of the camera moves in the direction closer to the three-dimensional object, an object 314 on which the three-dimensional object is projected may appear in a second image capturing a scene including the three-dimensional object at a second time point. The length of the projected object 314 may be a length (d′ₐₚ-d′). The length (d′ₐₚ-d′) may be shorter than the length (dₐₚ-d).

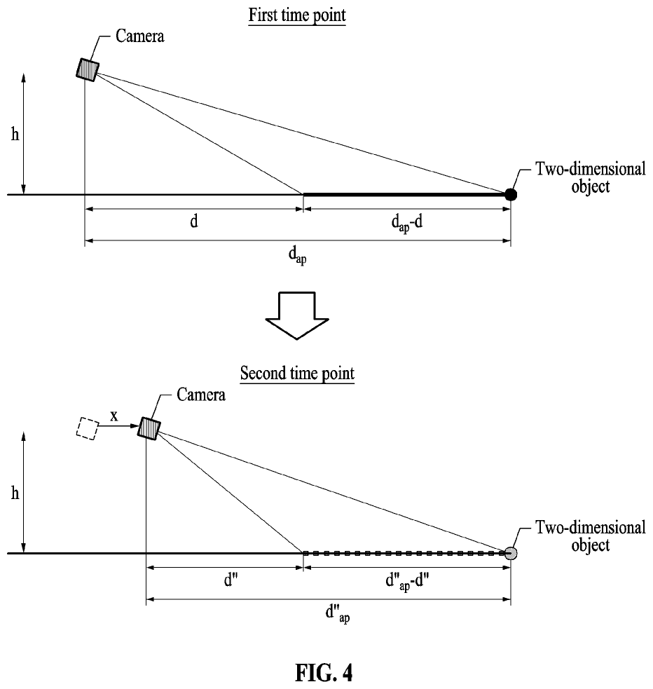

FIG. 4 illustrates an example of an object in an image appearing by a two-dimensional object.

At a first time point, a two-dimensional object 413 may appear in a first image capturing a scene including a two-dimensional object. A length (dₐₚ-d) of the two-dimensional object 413 may be invariable depending on the distance between a camera and the two-dimensional object.

When a position of the camera moves in the direction closer to the two-dimensional object, a two-dimensional object 414 may appear in a second image capturing a scene including the two-dimensional object at a second time point. The length of the two-dimensional object 414 may be a length (d″ₐₚ-d″). Since the two-dimensional object is a picture drawn on the ground, the length (d″ₐₚ-d″) may be the same as the length (dₐₚ-d).

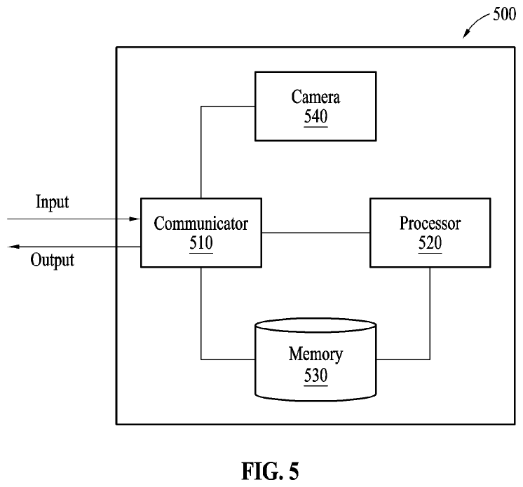

FIG. 5 is a diagram illustrating a configuration of an electronic device according to an embodiment.

According to an aspect, an electronic device 500 may include a communicator 510, a processor 520, and a memory 530. In addition, the electronic device 500 may further include a camera 540. The electronic device 500 may be included in a vehicle. For example, the electronic device 200 may be a device such as an electronic control unit (ECU) or a body control module (BCM). In another example, the electronic device 200 may be an independent device connected to an ECU/BCM.

The communicator 510 may be connected to the processor 520, the memory 530, and the camera 540 to transmit and receive data to and from the processor 520, the memory 530, and the camera 540. The communicator 510 may be connected to another external device and transmit and receive data to and from the external device. Hereinafter, transmitting and receiving “A” may refer to transmitting and receiving “information or data indicating A”.

The communicator 510 may be implemented as circuitry in the electronic device 500. For example, the communicator 510 may include an internal bus and an external bus. In another example, the communicator 510 may be an element that connects the electronic device 500 to an external device. The communicator 510 may be an interface. The communicator 510 may receive data from the external device and may transmit the data to the processor 520 and the memory 530.

The processor 520 may process the data received by the communicator 510 and the data stored in the memory 530. A “processor” may be a hardware-implemented data processing device having a physically structured circuit to execute desired operations. The desired operations may include, for example, code or instructions in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 520 may execute computer-readable code (e.g., software) stored in a memory (e.g., the memory 530) and instructions triggered by the processor 520.

The memory 530 may store the data received by the communicator 510 and the data processed by the processor 520. For example, the memory 530 may store a program (or an application or software). The stored program may be a set of syntaxes that are coded to detect an object and executable by the processor 520.

According to an aspect, the memory 530 may include at least one of volatile memory, non-volatile memory, random-access memory (RAM), flash memory, a hard disk drive, and an optical disk drive.

The memory 530 may store an instruction set (e.g., software) for operating the electronic device 500. The instruction set for operating the electronic device 500 may be executed by the processor 220.

The camera 540 may generate an image by capturing a scene. The camera 540 may be a monocular camera. For example, the camera 540 may be placed at the front of the vehicle.

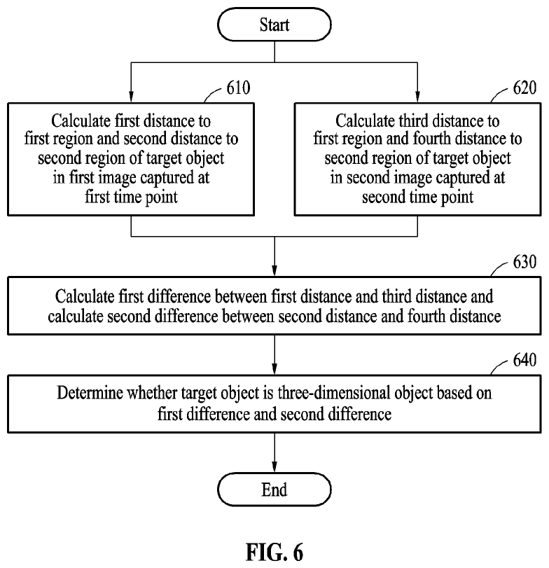

The communicator 510, the processor 520, the memory 530, and the camera 540 are described in detail below with reference to FIGS. 6 to 13.

FIG. 6 is a flowchart of a method of detecting an object, according to an embodiment.

Operations 610 to 640 described below may be performed by the electronic device 500 described above with reference to FIG. 5.

In operation 610, the electronic device 500 may calculate a first distance to a first region and a second distance to a second region of a target object in a first image captured at a first time point using a camera (e.g., the camera 540). For example, the first region may include the lowest part of the target object and the second region may include the uppermost part of the target object. The lowest part may be a part that is connected to the ground.

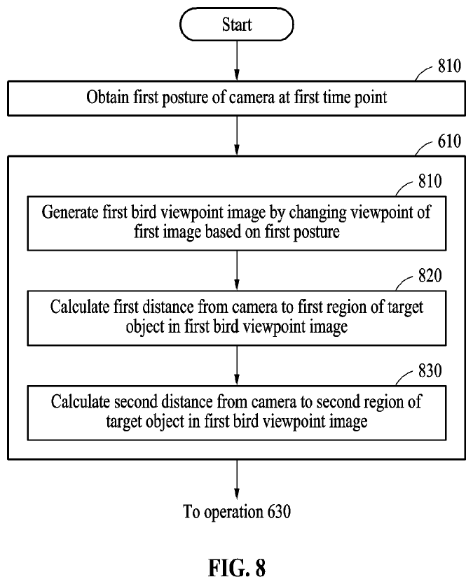

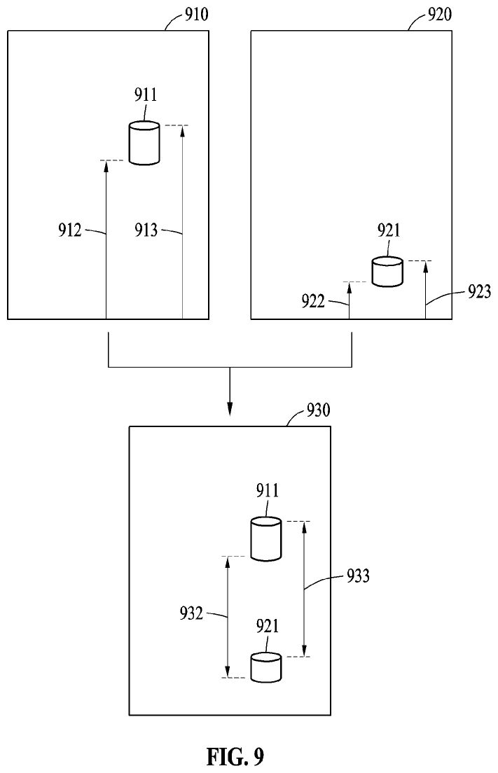

According to an embodiment, the first distance and the second distance may be calculated based on a first bird viewpoint image generated by changing a viewpoint of the first image to a bird viewpoint. Hereinafter, a method of calculating the first distance and the second distance based on the first bird viewpoint image is described in detail with reference to FIGS. 8 and 9.

In operation 620, the electronic device 500 may calculate a third distance to the first region and a fourth distance to the second region of the target object in a second image captured at a second time point using the camera. The second time point may be the time after the first time point. As the camera moves, the distance between the camera and the target object at the second time point may be closer than the distance between the camera and the target object at the first time point.

According to an embodiment, the third distance and the fourth distance may be calculated based on a second bird viewpoint image generated by changing a viewpoint of the second image to a bird viewpoint.

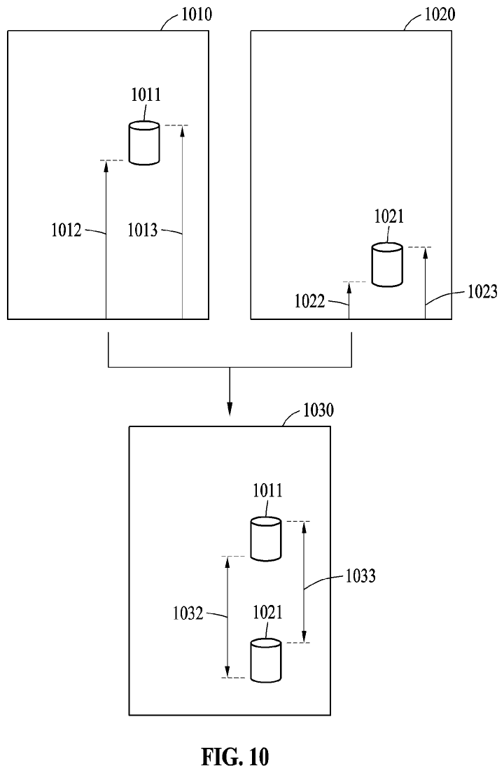

In operation 630, the electronic device 500 may calculate a first difference between the first distance and the third distance and may calculate a second difference between the second distance and the fourth distance. A method of calculating the first difference and the second difference is described below in detail with reference to FIG. 10.

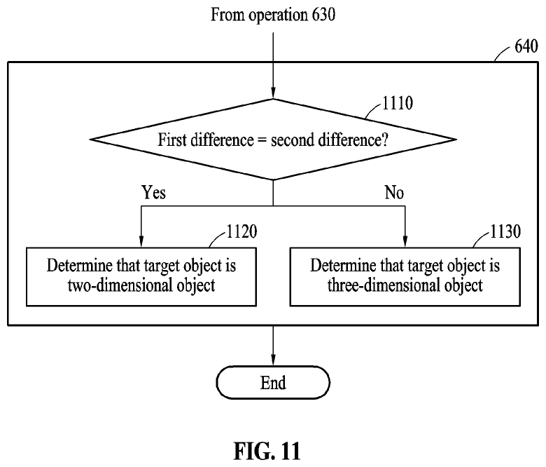

In operation 640, the electronic device 500 may determine whether the target object is a three-dimensional object based on the first difference and the second difference. For example, when the first difference is equal to the second difference, the target object may be determined to be a two-dimensional object. For example, when the first difference is not equal to the second difference, the target object may be determined to be a three-dimensional object. Hereinafter, a method of determining whether the target object is a three-dimensional object is described in detail with reference to FIG. 11.

According to an embodiment, when the electronic device 500 is included in a vehicle, control of the vehicle may vary depending on whether the target object is a three-dimensional object. For example, the three-dimensional object may be a hazardous object and an object to be avoided.

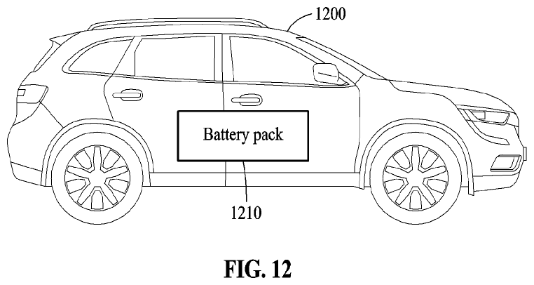

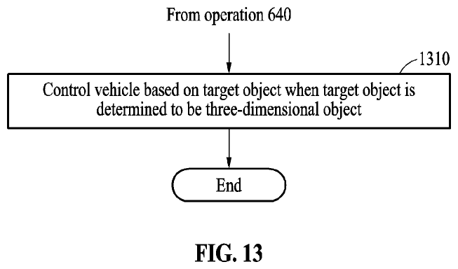

Hereinafter, a method of controlling a vehicle is described in detail with reference to FIGS. 12 and 13.

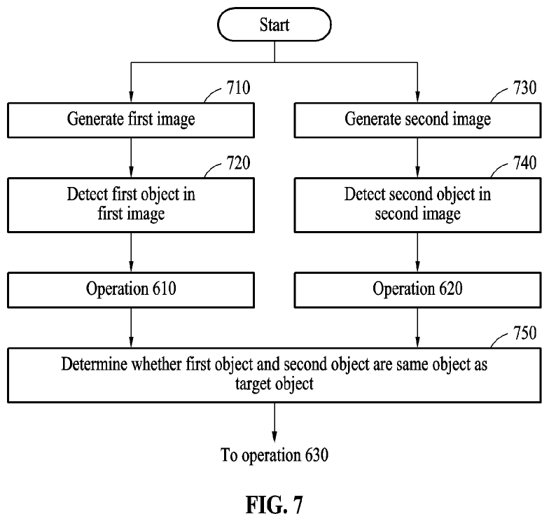

FIG. 7 is a flowchart of a method of determining whether objects in images are the same objects, according to an example.

According to an example, before determining whether a target object is a three-dimensional object, whether an object in a first image and an object in a second image are the same object may need to be determined. Operations 710 to 750 described below may be further performed for object matching.

In operation 710, the electronic device 500 may generate a first image at a first time point using a camera.

In operation 720, the electronic device 500 may detect a first object in the first image. There may be one or more objects detected in the first image. For example, the electronic device 500 may detect one or more objects in the first image using an object detection algorithm, and the object detection algorithm is not limited to a particular kind.

According to an example, after operation 720 is performed, operation 610 described above with reference to FIG. 6 may be performed. For example, in operation 610, the electronic device 500 may calculate the first distance and the second distance for each of the detected one or more objects.

According to an example, operations 710, 720, and 610 may be performed before operation 730 is performed.

In operation 730, the electronic device 500 may generate a second image at a second time point using the camera.

In operation 740, the electronic device 500 may detect a second object in the second image. There may be one or more objects detected in the second image.

According to an example, after operation 740 is performed, operation 620 described above with reference to FIG. 6 may be performed. For example, in operation 620, the electronic device 500 may calculate the third distance and the fourth distance for each of the detected one or more objects. The distances to the objects calculated in operation 620 are referred to as the third distance and the fourth distance, but when a third image at a third time point is generated, which is a time point after the second time point, the distances to the objects calculated in operation 620 may be referred to as the first distance and the second distance, since the second image is a preceding image of the third image.

According to an example, after operation 620 is performed, operation 750 may be performed.

In operation 750, the electronic device 500 may determine whether the first object and the second object are the same object as the target object. In other words, the electronic device 500 may determine whether the first object matches the second object. When the first object matches the second object, operation 630 described above with reference to FIG. 6 may be performed.

FIG. 8 is a flowchart of a method of calculating a first distance to a first region of a target object and a second distance to a second region of the target object in a first image, according to an example.

According to an embodiment, before operation 610 described above with reference to FIG. 6 is performed, operation 810 may be further performed.

In operation 810, the electronic device 500 may obtain a first posture of a camera at a first time point. For example, a posture of the camera may be obtained by a gyroscope or an acceleration sensor.

Operation 610 may include operations 820 to 840 described below.

In operation 820, the electronic device 500 may generate a first bird viewpoint image by changing a viewpoint of the first image to a bird viewpoint. In order to generate an accurate first bird viewpoint image, the first posture of the camera or an obtained (or estimated) slope of the ground may be additionally used.

In operation 830, the electronic device 500 may calculate the first distance from a reference point (e.g., a position of the camera) to the first region of the target object in the first bird viewpoint image.

In operation 840, the electronic device 500 may calculate the second distance from the reference point to the second region of the target object in the first bird viewpoint image.

Referring to FIG. 8, a method of calculating the first distance and the second distance based on the first bird viewpoint image of the first image is described, but the above description may be replaced with a description of generating a second bird viewpoint image based on a second image and calculating a third distance and a fourth distance using the second bird viewpoint image.

FIG. 9 illustrates an example of a calculated first difference and a calculated second difference when a target object is a three-dimensional object.

In a first bird viewpoint image 910 with respect to a first time point, a first distance 912 between a reference point and a first region that is the lowest region of a target object 911 may be calculated and a second distance 913 between the reference point and a second region that is the uppermost region of the target object 911 may be calculated. For example, the reference point may be a position of a camera from a bird viewpoint. In another example, the reference point may be bottom coordinates of a bird viewpoint image.

Similarly, in a second bird viewpoint image 920 with respect to a second time point, a third distance 922 between a reference point and a first region that is the lowest region of a target object 921 may be calculated and a fourth distance 923 between the reference point and a second region that is the uppermost region of the target object 921 may be calculated. As the camera gets closer to the actual object, the position of the target object 921 in the second bird viewpoint image 920 may be relatively lower than the position of the target object 911 in the first bird viewpoint image 910.

When the actual object is a three-dimensional object, motion parallax appears such that a first difference 932, which is the difference between the first distance and the third distance, may appear different from a second difference 933, which is the difference between the second distance and the fourth distance. For example, the second difference 933 may be greater than the first difference 932.

FIG. 10 illustrates an example of a calculated first difference and a calculated second difference when a target object is a two-dimensional object.

In a first bird viewpoint image 1010 with respect to a first time point, a first distance 1012 between a reference point and a first region that is the lowest region of a target object 1011 may be calculated and a second distance 1013 between the reference point and a second region that is the uppermost region of the target object 1011 may be calculated.

Similarly, in a second bird viewpoint image 1020 with respect to a second time point, a third distance 1022 between a reference point and a first region that is the lowest region of a target object 1021 may be calculated and a fourth distance 1023 between the reference point and a second region that is the uppermost region of the target object 1021 may be calculated. As the camera gets closer to the actual object, the position of the target object 1021 in the second bird viewpoint image 1020 may be relatively lower than the position of the target object 1011 in the first bird viewpoint image 1010.

When the actual object is a two-dimensional object, motion parallax does not appear such that a first difference 1032, which is the difference between the first distance and the third distance, may be equal to a second difference 1033, which is the difference between the second distance and the fourth distance.

FIG. 11 illustrates an example of a method of determining whether a target object is a three-dimensional object based on a first difference and a second difference.

According to an embodiment, operation 640 described above with reference to FIG. 6 may include operations 1110 to 1130 described below.

In operation 1110, the electronic device 500 may determine whether the first difference is equal to the second difference.

In operation 1120, the electronic device 500 may determine that the target object is a two-dimensional object when the first difference is equal to the second difference.

In operation 1130, the electronic device 500 may determine that the target object is a three-dimensional object when the first difference is not equal to the second difference.

FIG. 12 illustrates an example of a vehicle including an electronic device.

According to an embodiment, the electronic device 500 may be included in a vehicle 1200 supporting autonomous driving or a vehicle 1200 supporting an advanced driver-assistance system (ADAS).

According to an aspect, the vehicle 1200 may drive in an autonomous mode according to a recognized driving environment even when little or no inputs are provided from a driver. The driving environment may be recognized through one or more sensors attached or installed in the vehicle 1200. For example, the one or more sensors may include a camera, lidar, radar, and voice recognition sensors but are not limited thereto. The driving environment may include a road, a condition of the road, a type of lane line, the presence or absence of a nearby vehicle, a distance to a nearby vehicle, the weather, the presence or absence of an obstacle, and the like but is not limited thereto.

The vehicle 1200 recognizes the driving environment and generates an autonomous driving route appropriate for the driving environment. The autonomous vehicle controls internal and external mechanical elements to follow the autonomous driving route. The vehicle 1200 may periodically generate an autonomous driving route.

According to another aspect, the vehicle 1200 may assist a driver with driving using the ADAS. The ADAS may include an automatic emergency braking (AEB) system that in case the risk of collision is detected, automatically reduces the speed or stops the vehicle even when the driver does not step on the brake, a lane keep assist system (LKAS) that steers the vehicle to keep its lane when a vehicle moves out of the lane, an advanced smart cruise control (ASCC) that automatically controls a vehicle to maintain a distance to vehicles ahead or to drive at a predetermined speed, an active blind spot detection (ABSD) that detects the risk of collision in a blind spot and thereby helps the driver to change lanes safely, and an around view monitor (AVM) that visually displays the surrounding circumstances of a vehicle.

The electronic device 500 included in the vehicle 1200 may control the mechanical devices of the vehicle 1200 to autonomously drive or assist the driver with driving, and may be used for an ECU, BCM, and various types of controllers or sensors other than the described embodiment.

FIG. 13 is a flowchart of a method of controlling a vehicle based on a three-dimensional object, according to an example.

According to an embodiment, when the electronic device 500 is included in the vehicle 1200 described above with reference to FIG. 12, operation 1310 below may be performed after operation 640 described above with reference to FIG. 6 is performed.

In operation 1310, the electronic device may control the vehicle based on the target object when the target object is determined to be a three-dimensional object. For example, the electronic device 500 may control the vehicle 1200 to avoid the three-dimensional object when the object in an image is determined to be the three-dimensional object.

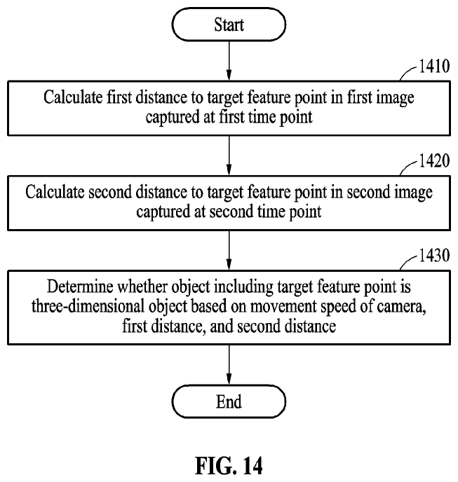

FIG. 14 is a flowchart of a method of detecting an object, according to another embodiment.

Operations 1410 to 1430 may be performed by the electronic device 500 described above with reference to FIGS. 5 to 13.

In operation 1410, the electronic device 500 may calculate a first distance to a target feature point in a first image captured at a first time point using a camera (e.g., the camera 540). For example, a scale-invariant feature transform (SIFT) or an oriented FAST and rotated BRIEF (ORB) descriptor may be used to detect a feature point in an image but is not limited to the described embodiments.

According to an embodiment, the electronic device 500 may convert the first image into a first bird viewpoint image in order to calculate the first distance. The description related thereto is omitted hereinafter, as the description of operations 810 to 840 described above with reference to FIG. 8 may be similarly applied.

In operation 1420, the electronic device 500 may calculate a second distance to the target feature point in a second image captured at a second time point using the camera.

In operation 1430, the electronic device 500 may determine whether an object including the target feature point is a three-dimensional object based on the movement speed of the camera, the first distance, and the second distance.

When a feature point in the first image matches a feature point in the second image, the electronic device 500 may calculate the speed at which the feature point has moved. For example, the speed at which the feature point has moved may be calculated based on the time between the first time point and the second time point and the difference between the first distance and the second distance.

The electronic device 500 may obtain the movement speed of the camera. For example, the movement speed of a vehicle including the electronic device 500 may correspond to the movement speed of the camera.

According to an embodiment, when the movement speed of the camera is equal to the movement speed of the feature point, an object including the feature point may be determined to be a two-dimensional object. For example, using clustering, a group of feature points may be considered as a single object.

According to an embodiment, when the movement speed of the camera is not equal to the movement speed of the feature point, the object including the feature point may be determined to be a three-dimensional object.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. An object detection method performed by an electronic device, the object detection method comprising:
calculating a first distance to a first region of a target object and a second distance to a second region of the target object in a first image captured at a first time point using a camera;
calculating a third distance to the first region of the target object and a fourth distance to the second region of the target object in a second image captured at a second time point using the camera;
calculating a first difference between the first distance and the third distance and calculating a second difference between the second distance and the fourth distance; and
determining whether the target object is a three-dimensional object based on the first difference and the second difference.

2. The three-dimensional object detection method of claim 1, wherein the camera is a monocular camera.

3. The three-dimensional object detection method of claim 1, wherein the first region comprises a lowest part of the target object, and the second region comprises an uppermost part of the target object.

4. The three-dimensional object detection method of claim 1, further comprising:
detecting a first object in the first image;
detecting a second object in the second image; and
determining whether the first object and the second object are the same object as the target object.

5. The three-dimensional object detection method of claim 1, wherein the calculating of the first distance to the first region of the target object and the second distance to the second region of the target object in the first image captured at the first time point using the camera comprises:
generating a first bird viewpoint image by changing a viewpoint of the first image;
calculating the first distance from the camera to the first region of the target object in the first bird viewpoint image; and
calculating the second distance from the camera to the second region of the target object in the first bird viewpoint image.

6. The three-dimensional object detection method of claim 5, further comprising:
obtaining a first posture of the camera at the first time point, wherein the generating of the first bird viewpoint image by changing the viewpoint of the first image comprises generating the first bird viewpoint image by changing the viewpoint of the first image based on the first posture.

7. The three-dimensional object detection method of claim 1, wherein the calculating of the third distance to the first region of the target object and the fourth distance to the second region of the target object in the second image captured at the second time point using the camera comprises:
obtaining a second posture of the camera at the second time point;
generating a second bird viewpoint image by changing a viewpoint of the second image based on the second posture;
calculating the third distance from the camera to the first region of the target object in the second bird viewpoint image; and
calculating the fourth distance from the camera to the second region of the target object in the second bird viewpoint image.

8. The three-dimensional object detection method of claim 1, wherein the determining of whether the target object is the three-dimensional object based on the first difference and the second difference comprises determining that the target object is a two-dimensional object when the first difference is equal to the second difference.

9. The three-dimensional object detection method of claim 1, wherein the determining of whether the target object is the three-dimensional object based on the first difference and the second difference comprises determining that the target object is the three-dimensional object when the first difference is not equal to the second difference.

10. The three-dimensional object detection method of claim 1, wherein the electronic device is included in a vehicle, and when the target object is determined to be the three-dimensional object, the target object is used to generate a path of the vehicle.

11. A non-transitory computer-readable storage medium storing instructions that, when executed by a processor, cause the processor to perform the method of claim 1.

12. An electronic device comprising:
a memory configured to store a program for detecting an object; and
a processor configured to execute the program, wherein the program is configured to perform:
calculating a first distance to a first region of a target object and a second distance to a second region of the target object in a first image captured at a first time point using a camera;
calculating a third distance to the first region of the target object and a fourth distance to the second region of the target object in a second image captured at a second time point using the camera;
calculating a first difference between the first distance and the third distance and calculating a second difference between the second distance and the fourth distance; and
determining whether the target object is a three-dimensional object based on the first difference and the second difference.

13. The electronic device of claim 12, wherein the electronic device is included in a vehicle supporting autonomous driving or a vehicle supporting an advanced driver-assistance system (ADAS).

14. The electronic device of claim 13, wherein the program is further configured to perform controlling the vehicle based on the target object when the target object is determined to be the three-dimensional object.

15. The electronic device of claim 12, wherein the electronic device further comprises the camera that is a monocular camera.

16. The electronic device of claim 12, wherein the first region comprises a lowest part of the target object, and the second region comprises an uppermost part of the target object.

17. The electronic device of claim 12, wherein the program is further configured to perform:
detecting a first object in the first image;
detecting a second object in the second image; and
determining whether the first object and the second object are the same object as the target object.

18. The electronic device of claim 12, wherein the calculating of the first distance to the first region of the target object and the second distance to the second region of the target object in the first image captured at the first time point using the camera comprises:
obtaining a first posture of the camera at the first time point;
generating a first bird viewpoint image by changing a viewpoint of the first image based on the first posture;
calculating the first distance from the camera to the first region of the target object in the first bird viewpoint image; and
calculating the second distance from the camera to the second region of the target object in the first bird viewpoint image.

19. The electronic device of claim 12, wherein the determining of whether the target object is the three-dimensional object based on the first difference and the second difference comprises:
determining that the target object is a two-dimensional object when the first difference is equal to the second difference; and
determining that the target object is the three-dimensional object when the first difference is not equal to the second difference.

20. An object detection method performed by an electronic device, the object detection method comprising:
calculating a first distance to a target feature point in a first image captured at a first time point using a camera;
calculating a second distance to the target feature point in a second image captured at a second time point using the camera; and
determining whether an object comprising the target feature point is a three-dimensional object based on a movement speed of the camera, the first distance, and the second distance.
